(19) United States
(12) Patent Application Publication
(10) Pub. No.: US 2025/0078604 A1
(43) Pub. Date: Mar. 6, 2025

(54) TEAM BASED FANTASY FOOTBALL

(71) Applicant: Chase Pratel, San Diego, CA (US)

(72) Inventor: Chase Pratel, San Diego, CA (US)

(21) Appl. No.: 18/820,900

(22) Filed: Aug. 30, 2024

Related U.S. Application Data
(60) Provisional application No. 63/580,210, filed on Sep. 1, 2023.

(51) Int. Cl. G07F 17/32; G06Q 50/34

(52) U.S. Cl. CPC G07F 17/3211; G06Q 50/34; G07F 17/3269; G07F 17/3288

(57) ABSTRACT

Systems, methods, and non-transitory computer-readable media for organizing graphical user interface (GUI) elements of a GUI of a computing device. An electronic processor generating a plurality of team GUI elements corresponding to a plurality of team tables. Transmitting the plurality of team GUI elements for display on the computing device via the GUI. Receiving a participant selection of a team GUI element of the plurality of team GUI elements that are displayed, wherein the team GUI element includes one or more records. Populating a first window of the GUI based on the participant selection of the team GUI element. Receiving a participant selection of a record of the one or more records of the participant selected team GUI element. Automatically adding the record to a roster GUI element of a second window of the GUI based on an attribute of a field of the record.

### RELATED APPLICATIONS

This application claims priority to U.S. Provisional Patent Application No. 63/580,210, filed on Sep. 1, 2023, the entire contents of which are hereby incorporated by reference.

### BACKGROUND

Fantasy sports are currently played using web-based applications. For example, current versions of fantasy football include fantasy football players (for example, participants) selecting individual players from different teams of the National Football League (NFL) to be part of a roster of the participant's team (i.e., fantasy football team). The fantasy football team's scoring is based on the performance of the individual players of the fantasy football team during NFL games.

### SUMMARY

Different versions of fantasy sports may be played using web-based applications. However, there are several challenges faced in integrating fantasy sports into user friendly web-based applications. Particularly, newer versions of fantasy sports such as a team-based fantasy sport face challenges of integrating drafting, rostering, and scoring into the web-based application. Examples provided herein overcome these challenges to present a user-friendly web-based application for team-based fantasy sports. Although examples of fantasy football is provided in the below description, the description is equally applicable to other fantasy sports.

In some aspects, the techniques described herein relate to a server system for organizing graphical user interface (GUI) elements of a GUI of a computing device, the server system including: a memory; and an electronic processor configured to: generate a plurality of team GUI elements corresponding to a plurality of team tables, transmit the plurality of team GUI elements for display on the computing device via the GUI, receive, via the GUI, a participant selection of a team GUI element of the plurality of team GUI elements that are displayed, wherein the team GUI element includes one or more records, populate a first window of the GUI based on the participant selection of the team GUI element, receive, via the GUI, a participant selection of a record of the one or more records of the participant selected team GUI element, and automatically add the record to a roster GUI element of a second window of the GUI based on an attribute of a field of the record.

In some aspects, the techniques described herein relate to a method for organizing graphical user interface (GUI) elements of a GUI of a computing device, the method including: generating, with an electronic processor, a plurality of team GUI elements corresponding to a plurality of team tables, transmitting, with the electronic processor, the plurality of team GUI elements for display on the computing device via the GUI, receiving, with the electronic processor via the GUI, a participant selection of a team GUI element of the plurality of team GUI elements that are displayed, wherein the team GUI element includes one or more records, populating, with the electronic processor, a first window of the GUI based on the participant selection of the team GUI element, receiving, with the electronic processor via the GUI, a participant selection of a record of the one or more records of the participant selected team GUI clement, and automatically adding, with the electronic processor, the record to a roster GUI element of a second window of the GUI based on an attribute of a field of the record.

In some aspects, the techniques described herein relate to a non-transitory computer-readable medium including instructions for organizing graphical user interface (GUI) elements of a GUI of a computing device that, when executed by an electronic processor, cause the electronic processor to perform a set of operations including: generating a plurality of team GUI elements corresponding to a plurality of team tables, transmitting the plurality of team GUI elements for display on the computing device via the GUI, receiving, via the GUI, a participant selection of a team GUI element of the plurality of team GUI elements that are displayed, wherein the team GUI element includes one or more records, populating a first window of the GUI based on the participant selection of the team GUI element, receiving, via the GUI, a participant selection of a record of the one or more records of the participant selected team GUI clement, and automatically adding the record to a roster GUI element of a second window of the GUI based on an attribute of a field of the record.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. In some embodiments, a cloud-based computing infrastructure may be used in which the various components may be geographically separated between one or more locations. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the application will become apparent by consideration of the detailed description and accompanying drawings.

### BRIEF DESCRIPTION OF THE DRAWINGS

FIG. 1 is a functional block diagram illustrating an example system for providing a web-based application including graphical user interface (GUI) elements of a GUI for team based fantasy sport, according to embodiments described herein.

FIG. 2 illustrates an example embodiment GUI element, according to embodiments described herein.

FIG. 3 is a simplified illustration of an example embodiment of team cards displayed in a GUI of FIG. 1, according to embodiments described herein.

FIG. 4 is a flowchart illustrating a method for organizing the GUI elements of the GUI of FIG. 1 during an initial team selection process, according to embodiments described herein.

FIGS. 5A-5B are a simplified illustrations of example embodiments of the GUI of FIG. 1, according to embodiments described herein.

FIG. 6 is a flowchart illustrating a method for organizing GUI elements of FIG. 1, according to embodiments described herein.

FIG. 7 is a flowchart illustrating a method for organizing GUI elements of FIG. 1, according to embodiments described herein.

FIG. 8 is a flowchart illustrating a method for modifying GUI elements of FIG. 1, according to embodiments described herein.

### DETAILED DESCRIPTION

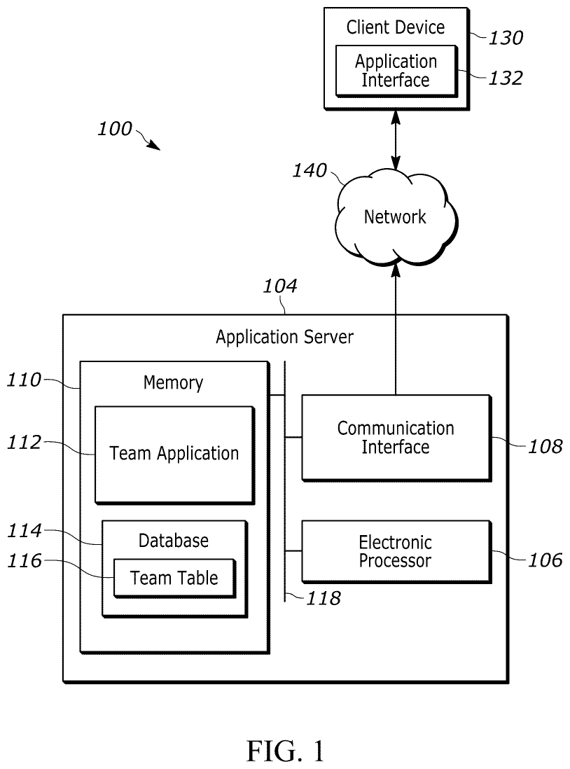

FIG. 1 is a functional block diagram illustrating an example system for providing a web-based application including graphical user interface (GUI) elements of a GUI of a computing device for team based fantasy sport, in accordance with various aspects of the present application. FIG. 1 provides only an illustration of one implementation and does not imply any limitations with regard to the environments in which different embodiments may be implemented. Many modifications to the depicted environment may be made by those skilled in the art without departing from the scope of the present application. In the example of FIG. 1, the system 100 includes an application server 104, a client device 130, and a network 140. In an embodiment, the system 100 includes the application server 104 and the client device 130, all interconnected over the network 140. The network 140 can be, for example, a local area network (LAN), a telecommunications network, a wide area network (WAN), such as the Internet, or any combination thereof, and includes wired, wireless, or fiber optic connections. In general, the network 140 can be any combination of connections and protocols, which will support communications between the application server 104 and the client device 130, in accordance with embodiments of the present application.

The application server 104 may be owned by, or operated by or on behalf of, an administrator. The application server 104 includes an electronic processor 106, a communication interface 108, and a memory 110. The electronic processor 106, the communication interface 108, and the memory 110 communicate over one or more control and/or data buses (for example, a communication bus 118). In some examples, the electronic processor 106 is implemented as a microprocessor with separate memory, such as the memory 110. In other examples, the electronic processor 106 may be implemented as a microcontroller (with memory 110 on the same chip). In other examples, the electronic processor 106 may be implemented using multiple processors. In addition, the electronic processor 106 may be implemented partially or entirely as, for example, a field-programmable gate array (FPGA), an applications specific integrated circuit (ASIC), an x86 processor, and the like and the memory 110 may not be needed or be modified accordingly. In the example illustrated, the memory 110 includes non-transitory, computer-readable memory/medium that stores instructions that are received and executed by the electronic processor 106 to carry out the functionality of the application server 104 described herein. The memory 110 may include, for example, a program storage area and a data storage area. The program storage area and the data storage area may include combinations of different types of memory, such as read-only memory and random-access memory. In some examples, the server 104 may include one electronic processor 106, and/or a plurality of electronic processors 106 in a cloud computer cluster arrangement, one or more of which may be executing none, all, or a portion of the applications or instructions of the server 104 provided below, sequentially or in parallel across the one or more electronic processors 106. The one or more electronic processors 106 comprising the server 104 may be geographically co-located or may be separated (for example, by miles), and interconnected via electronic and/or optical interconnects. One or more proxy servers or load balancing servers may control which one or more electronic processors 106 perform any, part, or all of the applications provided below.

The communication interface 108 may be implemented as one or both of a wired network interface and a wireless network interface. The communication interface 108 enables wired and/or wireless communication of the application server 104. Although shown within the application server 104, memory 110 may be, at least in part, implemented as network storage that is external to the application server 104 and accessed via the communication interface 108. For example, all or part of memory 110 may be housed on the “cloud.”

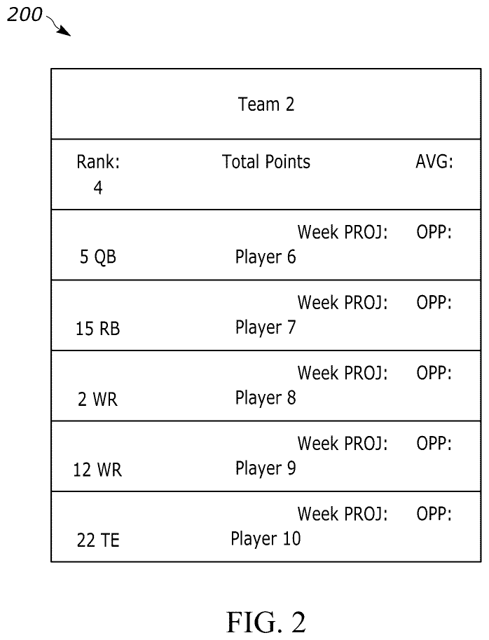

A team application 112 may be stored within the memory 110. The team application 112 may include machine readable instructions that are executed by the electronic processor 106 to perform the functionality of the application server 104 as described below with respect to FIGS. 2-8.

The memory 110 may include a database 114 for storing a team table 116 that includes information about a team, such as, for example roster of players. The team table 116 may include a plurality of records and/or a plurality of fields. The database 114 may be an RDF database, i.e., employ the Resource Description Framework. Alternatively, the database 114 may be another suitable database with features similar to the features of the Resource Description Framework, and various non-SQL databases, knowledge graphs, etc. The database 114 may include a plurality of the team tables 116. Each of the team tables 116 may be associated with and contain information (e.g., username) about a participant. For example, in the illustrated embodiment, the team table 116 may be associated with the individual associated with the client device 130, and other team tables 116 may be respectively associated with one of N other individuals (not expressly shown in FIG. 1). The team table 116 may also include data associated with device identifiers, team roster data, team schedules, statistics, and/or projected statistics.

In some implementations, the application server 104 may be a desktop computer, a computer server, or any other computer systems, known in the art. In some embodiments, the application server 104 represents computer systems utilizing clustered computers and components (e.g., database server computers, application server computers, etc.), which act as a single pool of seamless resources when accessed by the system 100. In general, the application server 104 is representative of any electronic device or combination of electronic devices capable of executing computer readable program instructions.

The client device 130 may be web-compatible mobile computer, such as a laptop computer, a tablet computer, a smart phone, a wearable computing device, or other suitable computing device. Alternately, or in addition, the client device 130 may be a desktop computer. The client device 130 includes a device electronic processor in communication with a device memory. The device electronic processor and the device memory may be implanted similarly as the electronic processor 106 and the memory 110 of the application server 104.

The client device 130 also includes an application interface 132. In some examples, the application interface 132 is an application, which contains software instructions implemented by the electronic processor of the client device 130 to perform the functions of the client device 130 as described herein, is stored within the memory of the client device 130. In some examples, the application interface 132 is a web interface accessible through an internet browser. In some examples, the application interface 132 is a mobile application of a tablet computer, a smart phone, a wearable computing device, or the like. The application may have a graphical user interface that facilitates interaction between a participant, the client device 130, and the application server 104. For example, the application interface 132 is a front-end application of the application server 104.

FIG. 2 is an example embodiment of a team card (e.g., GUI element) corresponding to the team table 116 stored in the memory 110. In the example illustrated, the application server 104, using the team application 112, creates a team GUI clement 200 using data of the team table 116. The team GUI element 200 displays the information of the team table 116 as team card on a display of a computing device (e.g., the client device 130). The team GUI element 200 can include a plurality of rows and a plurality of columns. For example, the team application 112 populates a row of the team GUI element 200 with attribute data corresponding to one or more fields of one or more records of the team table 116. In this example, a row of the team GUI clement 200 can include columns for team rank, total points of players of the team, team point average, player name, player numbers, player point projections, team opponent, or other information related to a team. In some embodiments, the team GUI element 200 includes one or more selection items. For example, the team GUI element 200 includes a wishlist icon (e.g., selection item). In this example, the team application 112 assigns/appends an identifier to the team GUI clement 200 when the wishlist icon is selected. In some implementations, the database 114 includes a plurality of the team tables 116.

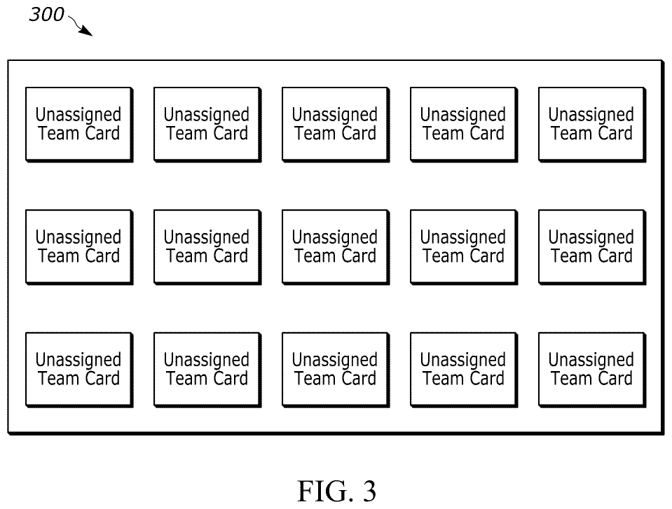

FIG. 3 is a simplified illustration of an example embodiment of team cards (e.g., (GUI element) displayed in a GUI of a web interface hosted on the application server 104. In the example illustrated, a web browser includes a GUI 300. The web browser is an application for accessing and retrieving information of a website. The web browser displays the information of the website on a display device computing device of a client. In some examples, the GUI 300 may be implemented on a mobile application. The GUI 300 is a digital interface in which a participant interacts with graphical components such as, for example, windows, icons, buttons, and menus. The GUI 300 provides visuals in a user interface conveying information relevant to the participant, as well as actions that the participant can take to interact with the team application 112 that is stored on the application server 104 and delivered over the Internet through a browser. The GUI 300 includes a plurality of team cards comparable to the team GUI clement 200 of FIG. 2. In this example, each of the plurality of team cards are not assigned an identifier associated with a participant. In some embodiments, the application server 104 generates the plurality of team GUI elements corresponding to a plurality of team tables. For example, the application server 104 retrieves a plurality of various instances of the team table 116 from the memory 110 and generates a plurality of team cards (e.g., team GUI elements). The application server 104 provides the plurality of team cards to the client device 130 for display to a participant via the network 140. In some embodiments, the application server 104 organizes the plurality of team cards in the GUI 300 based on respective ranks. In some embodiments, the GUI 300 is configured such that a single row of team cards is displayed to a participant via the network 140. In those embodiments, the GUI 300 is configured to cycle through the plurality of team cards based on a direction indicated by a user interaction (e.g., swipe) of a participant.

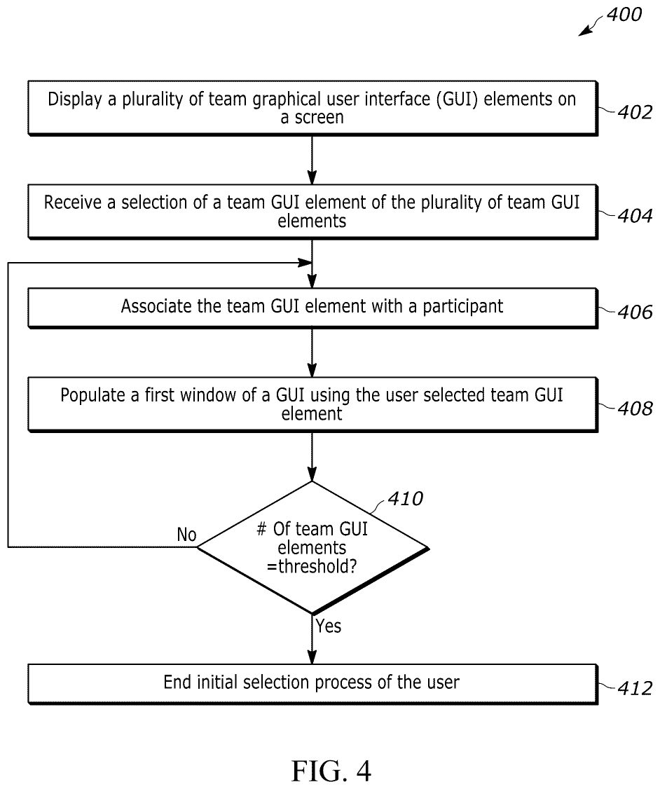

FIG. 4 is a flowchart illustrating a method 400 for organizing GUI elements of a GUI of a computing device for facilitating an initial team selection process for team based fantasy sport, in accordance with some embodiments. The method 400 may be performed by the application server 104 using the team application 112. In the example illustrated, the method 400 includes displaying, using the application server 104, a plurality of team GUI elements (at block 402). The application server 104 transmits the plurality of team cards (e.g., the team GUI elements 200) to application interface 132 of the client device 130 via the network 140. The team cards may be displayed in rows and/or columns, for example, similarly as shown in FIG. 3 on the application interfaces 132 of a plurality of client devices 130 in real time. The team cards are therefore displayed for selection by a plurality of participants. In some embodiments, the method 400 displays the team GUI elements 200 based on a wishlist selection of the first participant.

The method 400 includes receiving, using the application server 104, a selection of a team GUI element of the plurality of team GUI elements (at block 404). The application server 104 receives, via the application interface 132, an indication of a participant selecting a team card (that is, the team GUI element) of the plurality of team cards using a client device 130. Receiving the user selection may include determining that a user clicked on, touched (e.g., on a touch screen), or otherwise selected a team GUI element on the GUI 300. In some examples, only one participant of a plurality of participants is allowed to provide a selection of a team GUI element. For example, the plurality of participants may be selecting team GUI elements according to predetermined order. A first participant in the predetermined order is first allowed to select a team GUI element during the initial team selection process. During the turn of the first participant, the GUI 300 provides the plurality of team GUI elements to the first participants on an application interface 132 associated with the first participant. The remaining participants (for example, a second participant) may be prevented from selecting the team GUI elements during the turn of the first participant. That is, the selection functionality may be turned off for the remaining participants. For example, the application interfaces 132 associated with the remaining participants may show the plurality of team GUI elements, but may not allow the remaining participants to select the team GUI elements during the turn of the first participant. The turn of the first participant may be timed such that if a selection is not received during the time period, an automatic selection of a team GUI element based on a predetermined criteria may be performed by the method 400. In some examples, the method 400 may automatically select a team GUI clement based on a predetermined criteria when the first participant selects an option for automatic team selection in the application interface 132. In one example, the method 400 automatically selects the team GUI element 200 based on a wishlist selection of the first participant. In addition or alternatively, the method 400 automatically selects the team GUI clement 200 based on a rank of the team.

The method 400 includes also associating, using the application server 104, the team GUI element with a participant (at block 406). The application server 104 assigns an ID value associated with the participant to the team table 116 corresponding to the selected team card.

For example, the team card associated with the selected team GUI element is stored in a table or database format and related to the ID value of the participant that selected the team GUI element. Once a team GUI element is selected, other participants are prevented from being able to select the team GUI element. For example, the already selected team GUI element may be grated out in the GUI 300. The method 400 includes also populating, using the application server 104, a first window of a GUI 300 using the participant selected team GUI element (at block 408). The application server 104 transmits the selected team card to application interface 132 for display on the client device 130 via the network 140. The first window displays, for example, a fantasy team of a participant. The first window displays all the teams selected by the participant during the initial team selection process. The first window may be populated in real time as the participant is selecting the team cards.

The method 400 further includes determining, using the application server 104, whether the number of the participant selected team GUI elements is equal to a team GUI clement threshold (at block 410). The application server 104 determines the number of selected team cards the user selected via the application interface 132 and compares the number of selected team cards to a team GUI element threshold assigned to a user. In an instance, the application server 104 determines the number of selected team cards is less than the team GUI element threshold and returns to block 404 to receive another indication of the user of the client device 130 for selecting a team card of the plurality of team cards. In another instance, the application server 104 determines the number of selected team cards is equal to the team GUI element threshold and proceeds to block 412.

The method 400 includes also ending, using the application server 104, an initial team selection of the participant (at block 412). The application server disables, via the application interface 132, selection functionality of the participant of the client device 130 in response to determining that the team GUI element threshold is met. In some embodiments, the application server 104 modifies permissions of a user ID to make changes to the database 114.

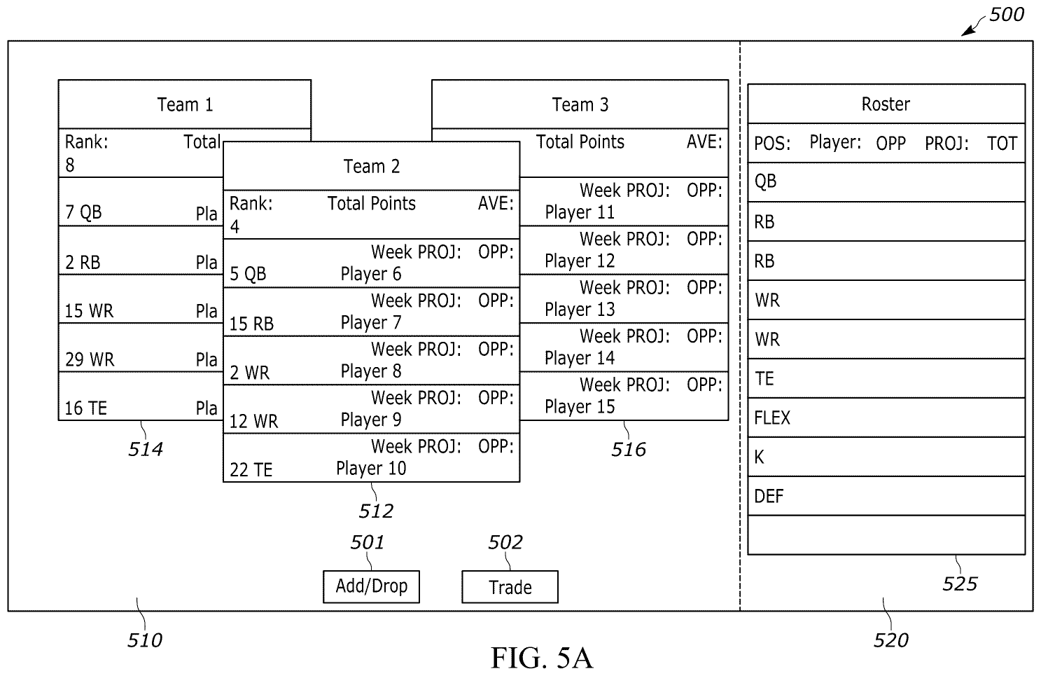

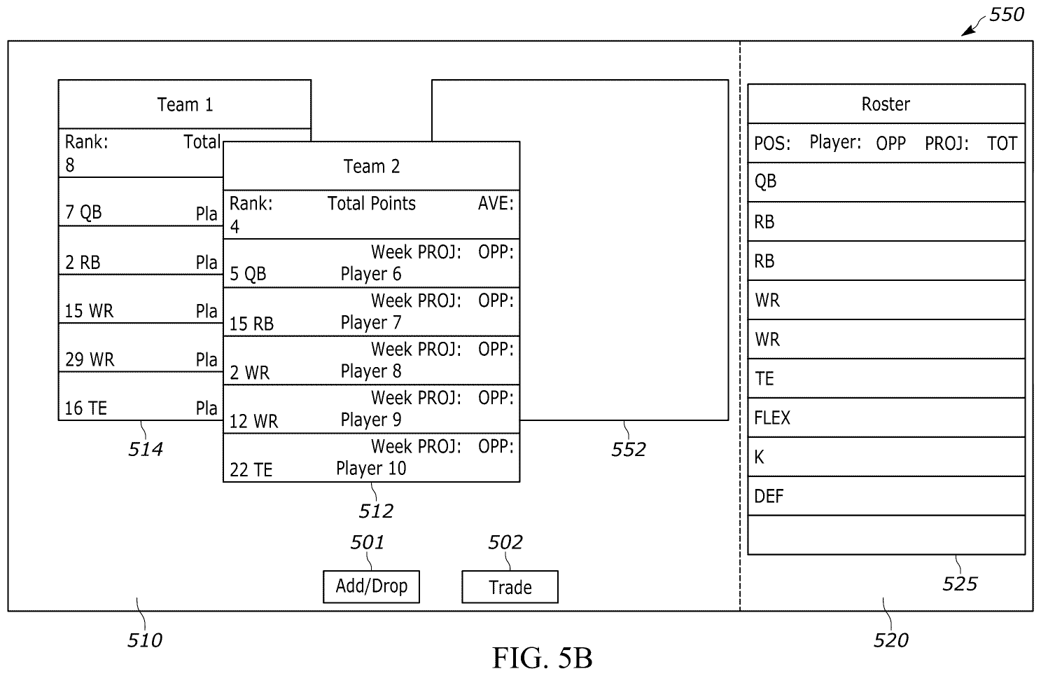

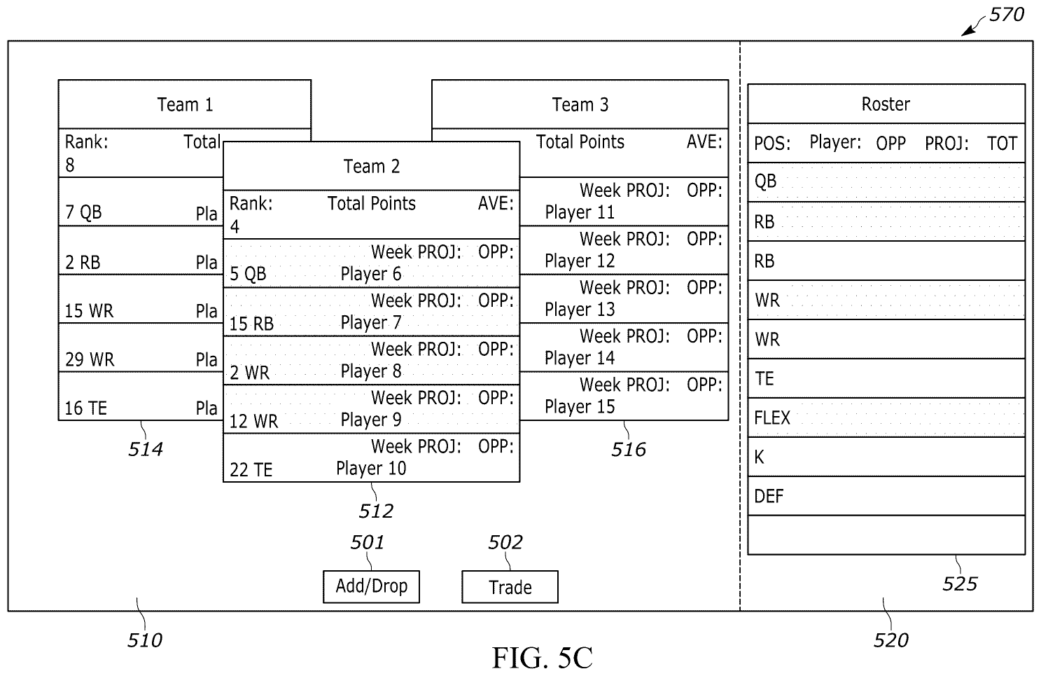

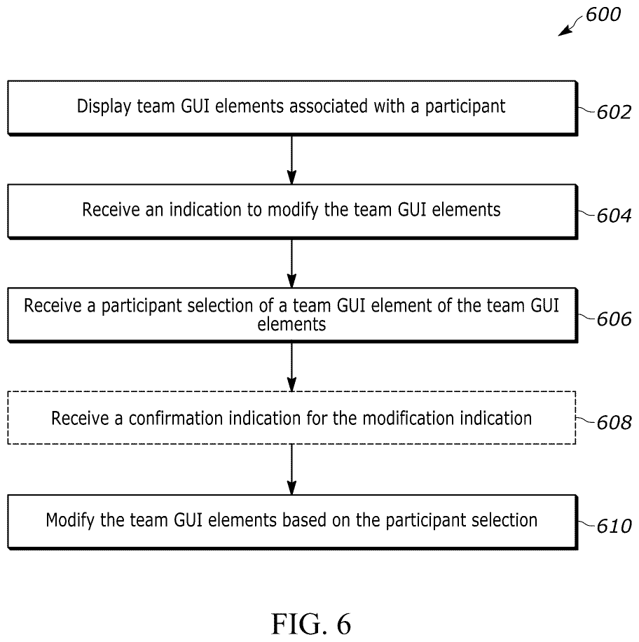

FIG. 5A is a simplified illustration of an example embodiment of a GUI of a web interface hosted on the application server 104, in accordance with some embodiments described herein. In the example illustrated, a web browser includes a GUI 500. The GUI 500 is comparable to the GUI 300 described above regarding FIG. 3. The GUI 500 includes a first sub-window 510 (e.g., first pane) and a second sub-window 520 (e.g., second pane). The first sub-window 510 displays one or more team cards (e.g., GUI elements) corresponding to the team tables 116. The application server 104 refers to the team tables 116 based on the ID value of the participant and retrieves the corresponding team cards. The retrieved team cards are displayed in the first sub-window 510. In this example, the first sub-window 510 includes an add/drop button 501, a trade button 502, a first team card 512, a second team card 514, and a third team card 516. The add/drop button 501 is GUI element that generates an indication requesting to modify the team cards associated with a user in the first sub-window 510. For example, the add/drop button 501 indicates a user request to unassign a team card of the first sub-window 510 or add an unassigned team card to the first sub-window 510, as discussed in greater detail below in reference to FIG. 6. The first team card 512, the second team card 514, and the third team card 516 include one or more players of a team. Each player is assigned a position. The first team card 512, the second team card 514, and the third team card 516 are GUI elements comparable to the team GUI element 200 of FIG. 2. In some implementations, the first sub-window 510 includes at least one team card. In those implementations, the number of team cards in the first sub-window 510 is defined by the number of total participants, the number of the team tables 116 available, and/or a set of preferences (e.g., rules) defined by a user (e.g., a league commissioner, administrator). In some embodiments, the GUI 500 a third sub-window. In other embodiments, the server 104 generates a third sub-window within the first sub-window 510 and/or the second sub-window 520. The third sub-window is configured such that a single row of team cards (e.g., unassigned team cards) is displayed to a participant via the network 140 and the GUI 500 is configured to cycle through the plurality of team cards based on a direction indicated by a user interaction (e.g., swipe) of a participant.

In some embodiments, the application server 104 populates the first sub-window 510 with team cards during an initial team selection process (e.g., draft). In those embodiments, the application server 104 generates a plurality of team cards (e.g., GUI elements) using the plurality of team tables 116 stored in memory 110. In some instances, the application server 104 displays a team card in the first sub-window 510 in response to a user selecting an unassigned team card (e.g., the first team card 512, the second team card 514, or the third team card 516) from the plurality of team cards. The application server 104 displays a team card in the first sub-window 510 in response to a user selection until a team GUI element threshold (e.g., team card threshold) of a user is met. The team GUI element threshold is defined by user preferences (e.g., league rules). In some instances, the application server 104 determines the number of team cards is equal to the team GUI element threshold and disables selection functionality of a user. For example, the application server 104 determines the team GUI element threshold is met by comparing the number of team tables 116 associated with an identifier of user to the team GUI element threshold.

The second sub-window 520 includes a roster GUI element 525. The roster GUI clement 525 is a configurable GUI element that allows a user to populate a roster table stored in the memory 110. The roster GUI element 525 includes columns having attributes such as, for example, player position, player name, opponent, player points projection, player total points, player category projections, or other related information. The roster GUI element 525 includes rows having attributes related to player positions such as, for example, quarterback, running back, wide receiver, tight end, flex, kicker, and defense. In some implementations, the roster GUI element 525 is populated by the team application 112 based on a user selecting a row (e.g., player) from the first team card 512, the second team card 514, and the third team card 516. In those implementations, application server 104 modifies a team roster table stored in the memory 110 resulting in modification of the roster GUI element 525.

FIG. 5B is an illustration of an example embodiment of a modification of a GUI of a web interface hosted on the application server 104, in accordance with some embodiments described herein. In the example illustrated, a web browser includes a GUI 550 corresponding to the GUI 500 of FIG. 5A. The GUI 550 provides visuals in a user interface conveying information relevant to the user, as well as actions that the user can take to interact with the team application 112 that is stored on the application server 104 and delivered over the Internet through a browser interface. The GUI 500 includes the first sub-window 510 and the second sub-window 520. The first sub-window 510 includes the add/drop button 501, the trade button 502, the first team card 512, the second team card 514, and a team card slot 552. The team card slot 552 is an unpopulated portion of the first sub-window 510. In some embodiments, the application server 104 unassigns an identifier value of the user from the third team card 516 removing the third team card 16 from the team card slot 552. In some embodiments, the application server 104 assigns an identifier value of the user to the third team card 516 adding the third team card 16 from the team card slot 552.

FIG. 5C is an illustration of an example embodiment of a modification of a GUI of a web interface hosted on the application server 104, in accordance with some embodiments described herein. In the example illustrated, a web browser includes a GUI 570 corresponding to the GUI 500 of FIG. 5A and the GUI 550 of FIG. 5B. The GUI 570 provides visuals in a user interface conveying information relevant to the user, as well as actions that the user can take to interact with the team application 112 that is stored on the application server 104 and delivered over the Internet through a browser interface. The GUI 500 includes the first sub-window 510 and the second sub-window 520. The first sub-window 510 includes the add/drop button 501, the trade button 502, the first team card 512, the second team card 514, and the third team card 516. In this instance, multiple rows of the first team card 512 include a gray overlay indicating a user selection via the application interface 132. The second sub-window 520 includes the roster GUI clement 525. In this instance, multiple rows of the roster GUI element 525 include a gray overlay indicating a destination for the selected rows of the first team card 512. The application server 104 receives, via the GUI 570, a participant selection of a record of the team table 116 linked to a corresponding row of the first team card 512. The application server 104 may automatically add the record of the team table 116 to a team roster table (not shown) linked to a corresponding row of the roster GUI element 525 of the second sub-window 520 based on an attribute of a field of the record of the team table 116. The application server 104 may automatically add the record of the team table 116 to a team roster table (not shown) linked to a corresponding row of the roster GUI element 525 of the second sub-window 520 based on an assigned/appended an identifier (e.g., wishlist identifier) of the team table 116.

In some embodiments, the application server 104 matches the attribute of a field of the record of the team table 116 with an attribute of a field of a record of the team roster table (not shown). The attributes of the fields indicating a position of a player. The application server 104 adds the record of the team table 116 to the record of the team roster table based on the matching attributes. In some implementations, the roster GUI element 525 includes a row (e.g., flex) allowing various players of different positions (e.g., RB, WR, TE) to be assigned to the row. In some implementations, the roster GUI element 525 includes multiple rows allowing players of the same positions (e.g., RB, WR) to be assigned to the multiple rows. In some embodiments, the application server 104 assigns a priority value to each record of the team roster table. In some embodiments, the application server 104 compares an attribute of a field of a first selected record of the team table 116 with an attribute of a field of a second selected record of the team table 116. The attributes of the fields indicating a points projection of a player. The application server 104 can add a first selected record or a second selected record to the record of the team roster table based on a result of the comparison. In addition or alternatively, the application server 104 adds the first selected record or the second selected record to the record of the team roster table based on the priority value assigned to the record. In some embodiments, the GUI 570 includes a filter button (not shown). The filter button is configured to select an attribute (e.g., RB, K, DEF, etc.) of a field (e.g., position) of the roster GUI element 525. The application server 104 receives selection from the filter button and extracts one or more records corresponding to records of players of the first team card 512, the second team card 514, and the third team card 516 with a matching field attribute that are not assigned to the roster GUI element 525. The application server 104 generates a new table the first sub-window 510 using the extracted records. The application server 104 can modify the records of the new table based on a selection of a different attribute for the field.

In some embodiments, the application server 104 limits, via the GUI 570, selection of rows by the participant to a set of team cards of the first sub-window 510 when populating the roster GUI element 525. The application server 104 prevents a participant from interacting with a sub-set of team cards by changing permissions (e.g., restrict access) of a user ID of the participant based on a team card selection threshold. The team card selection threshold is defined by user preferences. In some embodiments, the application server 104 changes permissions of the user ID of the participant restricting access to the team table 116 linked to the third team card 516 after receiving user selection queries for the team tables 116 linked to the first team card 512 and the second team card 514. In other embodiments, the application server 104 disables selection functionality, via the application interface 132, of the third team card 516 after receiving user selection interactions for the first team card 512 and the second team card 514.

In some embodiments, the application server 104 populates the roster GUI element 525 using an auto-setup mode and the first team card 512, the second team card 514, and/or the third team card 516. The application server 104 selects at least one of the first team card 512, the second team card 514, and the third team card 516 based on a team rank. In addition or alternatively, the application server 104 combines the week projected points of the players of each of the first team card 512, the second team card 514, and the third team card 516 and selects based on the total week projected points of each team card. The application server 104 populates the roster GUI element 525 using the team card selected based on rank and/or the total week projected points. The application server 104 may use other criteria, for example, predetermined criteria selected by the user to select the team cards.

In some embodiments, application server 104 combines records of the team tables 116 of a sub-set of the team cards. The application server 104 filters the players of the team table 116 that is created by the position field and the week projected points field. The team application 112 populates the roster GUI element 525 using the results of filtering the team table 116 that is created.

FIG. 6 is a flowchart illustrating a method 600 for organizing GUI elements of a GUI of a computing device for free agency and/or trade processes, in accordance with some embodiments described herein. The method 600 may be performed by the application server 104. In the example illustrated, the method 600 includes displaying, using the application server 104, team GUI element associated with a participant (at block 602). The application server 104 transmits team cards associated with an identifier value of a participant to application interface 132 of the client device 130 via the network 140.

The method 400 includes also receiving, using the application server 104, an indication to modify the team GUI elements (at block 604). The application server 104 receives an indication from the application interface 132 requesting the modification of the team tables 116 associated with the participant. In some embodiments, the application server 104 receives a request to assign the identifier value of the participant (e.g., add) to the team table 116 and/or unassign the identifier value of the participant (e.g., drop) from the team table 116. In some instances, the application server 104 receives a request to assign the identifier value of the participant (e.g., add) to the team table 116 that is not assigned to a participant (i.e., added during free agency). In some embodiments, the application server 104 receives a request to exchange the team table 116 associated with a first participant with the team table 116 associated with a second participant. For example, the application server 104 receives a request to reassign a first team card assigned to a first participant to a second participant and reassign a second team card assigned to the second participant to the first participant during a team card trade.

The method 600 includes also receiving, using the application server 104, a participant selection of a team GUI element of the team GUI elements (at block 606). The application server 104 receives, via the application interface 132, an indication of a participant of the client device 130 selecting the team table 116 (e.g., a team card) of the team tables 116 (e.g., team cards) associated with the user of the client device 130.

The method 600 optionally includes receiving, using the application server 104, a confirmation indication for the modification indication (at block 608). The application server 104 receives, via the application interface 132, an indication from another participant confirming acceptance of the modification request (e.g., trade request) for the team table 116 associated with the other participant. In some instances, an administrator also confirms the modification request for the team table 116.

The method 600 includes also modifying, using the application server 104, the team GUI elements based on the participant selection (at block 610). The application server 104 assigns or unassigns the identifier of the user of the client device 130 to the team tables 116 of the user selection received. In some embodiments, the application server 104 assigns the identifier value of the participant (e.g., add) to the team table 116 and/or unassigns the identifier value of the participant (e.g., drop) from the team table 116. In some instances, the application server assigns the identifier value of the participant (e.g., add) to the team table 116 that is not assigned to a participant (i.e., added during free agency). In some embodiments, the application server 104 exchanges the team table 116 associated with a first participant with the team table 116 associated with a second participant. For example, the application server 104 reassigns a first team card assigned to a first participant to a second participant and reassigns a second team card assigned to the second participant to the first participant during a team card trade.

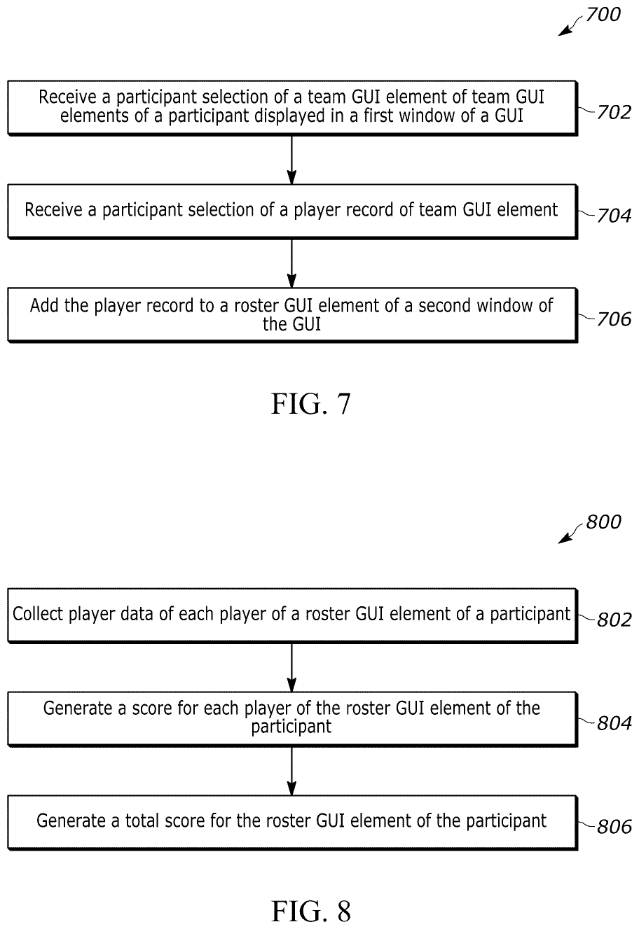

FIG. 7 is a flowchart illustrating a method 700 for organizing GUI elements of a GUI of a computing device for setting a roster, in accordance with some embodiments described herein. The method 700 may be performed by the application server 104. In the example illustrated, the method 700 includes receiving, using the application server 104, a participant selection of a team GUI element of team GUI elements of a user displayed in a first window of a GUI (at block 702). The application server 104 receives, via the application interface 132, an indication of a participant of the client device 130 selecting the team table 116 (e.g., a team card) of the team tables 116 (e.g., team cards) displayed in a first window (e.g., the first sub-window 510) of the application interface 132 of the client device 130.

The method 700 includes receiving, using the application server 104, a participant selection of a player record of the participant selected team GUI element (at block 704). The application server 104 receives, via the application interface 132, a participant selection of a record (i.e., row) of the one or more records of the user selected team card. The row of the participant selected team card is linked to a record of the team table 116. In some embodiments, the application server 104 limits, via the application interface 132, selection of rows by the participant to a first participant selected team card and a second participant selected team card of the first window when the team GUI element threshold is greater than two team GUI elements.

The method 700 includes also adding, using the application server 104, the player record to a roster GUI element of a second window of the GUI (at block 706). The application server 104 automatically adds the record of the participant selected team card to a roster GUI clement (e.g., the roster GUI element 525) of a second window (e.g., the second sub-window 520) of the application interface 132 based on an attribute of a field of the record. For example, the application server 104 automatically adds a record of the team table 116 linked with a participant selected row of a user selected team card to a record of the team table 116 linked with a team roster table (not shown) of the roster GUI element. In some examples, the application server 104 may prevent the player record from the team GUI element from being reselected once the player record is added to the roster GUI element. Additionally, the application server 104 may prevent player records from other team GUI elements that share an attribute (e.g., position) as the already selected player record. This selection may be prevented when the number of player records selected matching the attribute meets the allowed number of player records matching the attribute.

FIG. 8 is a flowchart illustrating a method 800 for modifying GUI elements of a GUI of a computing device for a roster, in accordance with some embodiments described herein. The method 800 may be performed by the application server 104. In the example illustrated, the method 800 includes collecting, using the application server 104, player data of each player of a roster GUI element of a participant (at block 802). The application server 104 receives player statistics (e.g., event data) from a remote server (not shown) for each player of a record of a team roster table (not shown) corresponding to the roster GUI element and stores the player statistics in the memory 110. In some embodiments, once the roster GUI element 525 is set, the application server 104 retrieves player statistics from a remote server (not shown) for each player of the roster GUI element 525.

The method 800 includes also generating, using the application server 104, a score for each player of the roster GUI element of the participant (at block 804). The application server 104 determines, using the player statistics (e.g., event data) stored in the memory 110, a score for each record of the team table 116 linked with the team roster table (not shown) of the roster GUI element. For example, the application server 104 calculates a score for each player of the roster GUI element 525 based on the player statistics. In some embodiments, the application server 104 assigns a defined value (e.g., numerical value) to a record of the team table 116 linked with the team roster table (not shown) of the roster GUI element according to a set of scoring rules of the team application 112. The scoring rules may be defined by preferences of a participant. The application server 104 determines, using the score for each record of the team table 116, a total score for the team table 116 linked with the team roster table (not shown) of the roster GUI element.

The method 800 includes also generating, using the application server 104, a total score for the roster GUI element of the user (at block 806). For example, the application server 104 calculates a score for each row of the roster GUI element 525 based on the player statistics (e.g., event data). The application server 104 assigns a score value to a total points field of a record of a team roster table (not shown) linked to the roster GUI element 525.

Various features and advantages of the present application are set forth in the following claims.

What is claimed is:

1. A server system for organizing graphical user interface (GUI) elements of a GUI of a computing device, the server system comprising:
a memory; and
an electronic processor configured to:
generate a plurality of team GUI elements corresponding to a plurality of team tables,
transmit the plurality of team GUI elements for display on the computing device via the GUI,
receive, via the GUI, a participant selection of a team GUI element of the plurality of team GUI elements that are displayed, wherein the team GUI element includes one or more records,
populate a first window of the GUI based on the participant selection of the team GUI element,
receive, via the GUI, a participant selection of a record of the one or more records of the participant selected team GUI element, and
automatically add the record to a roster GUI element of a second window of the GUI based on an attribute of a field of the record.

2. The server system of claim 1, wherein the electronic processor is further configured to:
in response to determining that a team GUI element threshold is met, disable, via the GUI, selection functionality of a participant.

3. The server system of claim 2, wherein the electronic processor is further configured to:
limit, via the GUI, selection of records by the participant to a first team GUI element and a second team GUI element of the first window of the GUI, wherein the team GUI element threshold is greater than two team GUI elements.

4. The server system of claim 3, wherein the electronic processor is further configured to:
change a permission of a participant ID of the participant to restrict access to a team table linked to a third team table.

5. The server system of claim 3, wherein populating the first window of the GUI based on the participant selection of the team GUI element, the electronic processor is further configured to:
combine records of tables of the first team GUI element and the second team GUI element of a sub-set of the plurality of team GUI elements;
filter the combined records of the tables; and
add, from the combined records of the tables, a record to a roster table of the roster GUI element based on a projected points field.

6. The server system of claim 1, wherein populating the first window of the GUI based on the participant selection of the team GUI element the electronic processor is further configured to:
add all records of the participant selected team GUI element to a roster table of the roster GUI element.

7. The server system of claim 1, wherein the electronic processor is further configured to:
collect event data of the record of the roster GUI element,
determine, using the event data, a score for the record of the roster GUI element, and
generate a total score for the roster GUI element based on the record of the roster GUI element.

8. A method for organizing graphical user interface (GUI) elements of a GUI of a computing device, the method comprising:
generating, with an electronic processor, a plurality of team GUI elements corresponding to a plurality of team tables,
transmitting, with the electronic processor, the plurality of team GUI elements for display on the computing device via the GUI,
receiving, with the electronic processor via the GUI, a participant selection of a team GUI element of the plurality of team GUI elements that are displayed, wherein the team GUI element includes one or more records,
populating, with the electronic processor, a first window of the GUI based on the participant selection of the team GUI element,
receiving, with the electronic processor via the GUI, a participant selection of a record of the one or more records of the participant selected team GUI element, and
automatically adding, with the electronic processor, the record to a roster GUI element of a second window of the GUI based on an attribute of a field of the record.

9. The method of claim 8, further comprising:
in response to determining that a team GUI element threshold is met, disabling, via the GUI, selection functionality of a participant.

10. The method of claim 9, further comprising:
limiting, via the GUI, selection of records by the participant to a first team GUI element and a second team GUI element of the first window of the GUI, wherein the team GUI element threshold is greater than two team GUI elements.

11. The method of claim 10, further comprising:
changing a permission of a participant ID of the participant to restrict access to a team table linked to a third team table.

12. The method of claim 10, wherein populating the first window of the GUI based on the participant selection of the team GUI element, the method further comprises:
combining records of tables of the first team GUI element and the second team GUI element of a sub-set of the plurality of team GUI elements;
filtering the combined records of the tables; and
adding, from the combined records of the tables, a record to a roster table of the roster GUI element based on a projected points field.

13. The method of claim 8, wherein populating the first window of the GUI based on the participant selection of the team GUI element, the method further comprises:
adding all records of the participant selected team GUI element to a roster table of the roster GUI element.

14. The method of claim 9, further comprising:
collecting event data of the record of the roster GUI element,
determining, using the event data, a score for the record of the roster GUI element, and
generating a total score for the roster GUI element based on the record of the roster GUI element.

15. A non-transitory computer-readable medium comprising instructions for organizing graphical user interface (GUI) elements of a GUI of a computing device that, when executed by an electronic processor, cause the electronic processor to perform a set of operations comprising:
generating a plurality of team GUI elements corresponding to a plurality of team tables,
transmitting the plurality of team GUI elements for display on the computing device via the GUI,
receiving, via the GUI, a participant selection of a team GUI element of the plurality of team GUI elements that are displayed, wherein the team GUI element includes one or more records,
populating a first window of the GUI based on the participant selection of the team GUI element,
receiving, via the GUI, a participant selection of a record of the one or more records of the participant selected team GUI element, and
automatically adding the record to a roster GUI element of a second window of the GUI based on an attribute of a field of the record.

16. The non-transitory computer-readable medium of claim 15, further comprising:
in response to determining that a team GUI element threshold is met, disabling, via the GUI, selection functionality of a participant.

17. The non-transitory computer-readable medium of claim 16, further comprising:
limiting, via the GUI, selection of records by the participant to a first team GUI element and a second team GUI element of the first window of the GUI, wherein the team GUI element threshold is greater than two team GUI elements.

18. The non-transitory computer-readable medium of claim 17, further comprising:
changing a permission of a participant ID of the participant to restrict access to a team table linked to a third team table.

19. The non-transitory computer-readable medium of claim 15, wherein, populating the first window of the GUI based on the participant selection of the team GUI element, further comprises:
adding all records of the participant selected team GUI element to a roster table of the roster GUI element.

20. The non-transitory computer-readable medium of claim 15, further comprising:
collecting event data of the record of the roster GUI element,
determining, using the event data, a score for the record of the roster GUI element, and
generating a total score for the roster GUI clement based on the record of the roster GUI clement.
